(19) United States
(12) Patent Application Publication
(10) Pub. No.: US 2015/0256664 A1
(43) Pub. Date: Sep. 10, 2015

(54) METHOD AND APPARATUS FOR DISPLAYING MEMO EVENTS

(71) Applicants: BEIJING LENOVO SOFTWARE LTD., Beijing (CN); LENOVO (BEIJING) LIMITED, Beijing (CN)

(72) Inventor: Cheng Guo, Beijing (CN)

(21) Appl. No.: 14/494,130

(22) Filed: Sep. 23, 2014

(30) Foreign Application Priority Data
Mar. 7, 2014 (CN) 201410084249.5

(51) Int. Cl. H04M 1/725; G08B 21/24

(52) U.S. Cl. CPC H04M 1/72522; G08B 21/24

(57) ABSTRACT

The present disclosure discloses a method and apparatus for displaying memo events, and relates to the field of communication. The method comprises acquiring M contact information involved in a communication event being handled, where M≧1; determining N contact information from the M contact information, the N contact information being bound to corresponding memo events, respectively; displaying corresponding memo events bound, respectively, to the N contact information, when the N contact information are displayed. By means of determining N contact information of M contact information involved in a communication event being handled, and displaying corresponding memo events bound, respectively, to the N contact information when the N contact information are displayed, the present disclosure can ensure that the memo events associated with the contact information involved in the communication event being handled may be displayed timely. In this way, the efficiency for reminding a user to handle memo events is improved. In addition, because the need for the user to manually trigger the displaying of the memo events, the present disclosure may avoid a situation where a user forgets checking the memo events, and the success rate of reminding a user to handle memo events is high.

CROSS-REFERENCE TO RELATED APPLICATION(S)

This application claims priority to Chinese Application No. 201410084249.5, entitled “Method and APPARATUS for DISPLAYING MEMO EVENTS”, filed on Mar. 7, 2014, which is incorporated herein by reference in its entirety.

### BACKGROUND

1. Technical Field

The present disclosure relates to the field of communication, in particular, to a method and apparatus for displaying memo events.

2. Related Art

With the development of communication technology, a terminal can implement more and more functionalities. For example, in order to avoid forgetting to handle certain events, a user may treat the events to be handled as memo events, and record them into a notepad or other applications installed in a terminal. After the user records the memo events in the corresponding terminal, in order to timely remind the user of the memo events to be handled, there is a need to provide a method for displaying memo events.

There are two types of conventional solutions for displaying memo events in the related art. The first type of solution comprises: obtaining an instruction to display a memo event by a user automatically triggering an application for recording the memo event, and displaying the memo event according to the obtained instruction. The second type of solution comprises: obtaining reminder time while the memo event recorded by a user is obtained, the reminder time being set by the user for displaying a memo event, and displaying the memo event when the set reminder time is reached.

During the implementation of the present application, the inventor finds out that the existing solutions in the related art have at least the following drawbacks.

As to the first type of solution mentioned above, the user is required to initiatively trigger an application for recording a memo event so as to display the memo event. If the user does not initiatively trigger the application for recording a memo event, the memo event cannot be displayed. In this case, if the user forgets to trigger the application for recording the memo event to review the recorded memo event, the memo event will not be displayed to remind the user to handle the memo event. This may result in the user failing to handle the memo event. Thus, the success rate of reminding a user to handle memo events is relatively low. For the second type of solution, because a memo event is displayed by setting reminder time for the memo event, the memo event is displayed only when the reminder time for the memo event is reached. In this way, the second type of solution cannot remind the user of the memo event to be handled in real time, and therefore results in low efficiency for the user to handle memo events.

### SUMMARY

In order to address the technical problems in the related art, the present disclosure provides a method and apparatus for displaying memo events. The technical solutions are as follows:

In a first aspect, the present disclosure provides a method for displaying memo events. The method comprises: acquiring M contact information involved in a communication event being handled, where M≧1; determining N contact information from the M contact information, the N contact information being bound to corresponding memo events, respectively; and displaying corresponding memo events which are bound, respectively, to the N contact information when the N contact information are displayed.

In a second aspect, the present disclosure provides an apparatus for displaying memo events. The apparatus comprises: a first acquiring module configured for acquiring M contact information involved in a communication event being handled, where M≧1; a determination module configured for determining N contact information from the M contact information, the N contact information being bound to corresponding memo events, respectively; and a display module configured for displaying corresponding memo events bound, respectively, to the N contact information, when the N contact information are displayed.

### BRIEF DESCRIPTION OF THE DRAWINGS

In order to illustrate the technical solutions according to the embodiments of the present disclosure more clearly, a brief description of the figures referenced in the following description of the embodiments will be given. Obviously, the figures described below relate to only some embodiments of the present disclosure, and those skilled in the art can contemplate other figures in light of the figures described below without any inventive effort.

FIG. 1 is a flow chart of a method for displaying memo events according a first embodiment of the present application;

FIG. 2 is a flow chart of a method for displaying memo events according a second embodiment of the present application;

FIG. 3 is a schematic diagram showing a terminal interface for displaying memo events according to a second embodiment of the present application;

FIG. 4 is a block diagram of a first kind of apparatus for displaying memo events according to a third embodiment of the present application;

FIG. 5 is a block diagram of a second kind of apparatus for displaying memo events according to a third embodiment of the present application;

FIG. 6 is a block diagram of a third kind of apparatus for displaying memo events according to a third embodiment of the present application;

FIG. 7 is a block diagram of a fourth kind of apparatus for displaying memo events according to a third embodiment of the present application;

FIG. 8 is a block diagram of a fifth kind of apparatus for displaying memo events according to a third embodiment of the present application; and

FIG. 9 is a block diagram of a sixth kind of apparatus for displaying memo events according to a third embodiment of the present application.

### DETAILED DESCRIPTION OF THE EMBODIMENTS

To show the objects, technical solutions, and advantages of the present disclosure more clearly, the embodiments of the present disclosure will be described in details with reference to the figures.

### The First Embodiment

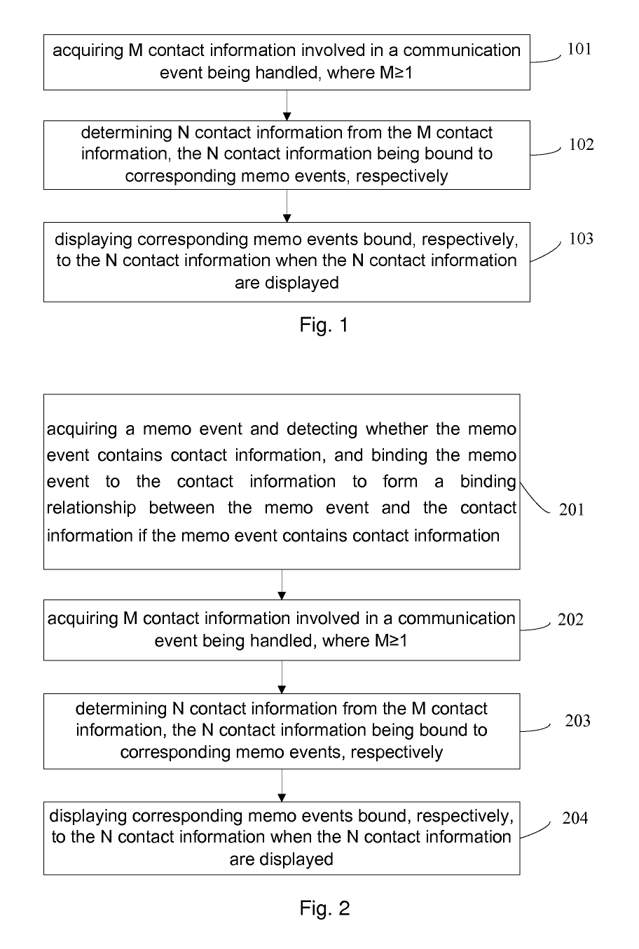

In order to be able to display memo events conveniently for improving the efficiency for a user handling memo events, an embodiment of the present disclosure provides a method for displaying memo events. In the method according to the embodiment of the present disclosure, if a memo event acquired by a terminal is related to some contact, the memo event may be bound to the contact, such that the memo event corresponding to the contact information of the contact can be displayed when the contact information is displayed on the terminal. Referring to FIG. 1, the method of the embodiment of the present disclosure comprises steps of:
101: acquiring M contact information involved in a communication event being handled, where M≧1;
102: determining N contact information from the M contact information, the N contact information being bound to corresponding memo events, respectively;
103: displaying corresponding memo events bound, respectively, to the N contact information when the N contact information are displayed.

Preferably, the method further comprises steps of
acquiring a memo event, and detecting whether the memo event contains contact information;
if the memo event contains contact information, binding the memo event with the contact information to form a binding relationship between the memo event and the contact information.

Preferably, the method further comprises, after the acquiring of the memo event:
acquiring reminder time set for the memo event, and

the method further comprises, after the binding of the memo event to the contact information:
detecting whether the current time has overrun the reminder time set for the memo event, and
if the current time has overrun the reminder time set for the memo event, automatically unbinding the binding relationship between the memo event and the contact information.

Preferably, the method further comprises, after the binding of the memo event to the contact information:
synchronizing the binding relationship to at least one bound terminal, such that the at least one bound terminal detects in real time whether a communication with a contact corresponding to the contact information in the binding relationship is being performed; and if the bound terminal detects that the communication with the contact corresponding to the contact information in the binding relationship is being performed, the bound terminal displays memo events corresponding to the contact information.

Preferably, the method further comprises, before the synchronizing of the binding relationship to the at least one bound terminal:
binding to the at least one bound terminal.

Preferably, the method further comprises, after the binding of the memo event to the contact information:
submitting the binding relationship to a server, such that the at least one bound terminal, when a communication event is handled, retrieves the binding relationship from the server, and determining whether the contact information involved in the communication event being handled exists in the binding relationship, and displaying memo events corresponding to the contact information when the contact information is displayed if it is determined that the contact information involved in the communication event being handled exists in the binding relationship.

By means of acquiring N contact information of M contact information involved in a communication event being handled, and displaying corresponding memo events bound to the N contact information, respectively, when the N contact information are displayed, the embodiment of the present application can ensure that if there is any communication event being handled, then memo events associated with contact information involved in the communication event being handled may be displayed, so as to improve the efficiency for reminding a user to handle memo events. In addition, because the need for the user to manually trigger the displaying of the memo events is avoided, the embodiment can avoid the situation where a user forgets checking memo events, and therefore the success rate of reminding a user to handle memo events is high.

### The Second Embodiment

In combination with the contents of the first embodiment mentioned above, an embodiment of the present disclosure provides a method for displaying memo events. With reference to FIG. 2, the method of the embodiment of the present disclosure comprises:
201: acquiring a memo event and detecting whether the memo event contains contact information, and if the memo event contains contact information, binding the memo event to the contact information to form a binding relationship between the memo event and the contact information.

In order to display memo events conveniently, in the embodiment of the present disclosure, a memo event may be bound to a contact associated with the memo event. Thus, after a memo event is acquired, it can be detected whether the memo event contains contact information. If the memo event contains contact information, the memo event may be bound to the contact information, to form a binding relationship between the memo event and the contact information.

There may be a plurality of ways for acquiring a memo event. For example, the memo event may be acquired from the application for recording memo events. Alternatively, the memo event may be acquired from a calendar application, and so on. The present disclosure poses no specific limitation on the details of the memo event. For example, a memo event may be an event to be handled by the user himself/herself who has recorded the memo event; or may be an event to be handled by the user who has recorded the memo event together with others, or may be an event for which others will be reminded for handling, and the like. The embodiment of the disclosure also poses no specific limitation on the details about the contact information. For example, the contact information may include, but not limited to, phone number of a contact, an e-mail address of a contact, and etc.

The embodiment of the disclosure poses no specific limitation on the implementation for detecting whether a memo event contains contact information. In an implementation, it may comprise, but not limited to, binding in advance the application for obtaining a memo event to the application for recording contact information. Thus, a possible implementation for detecting whether the memo event contains contact information may comprise, upon a memo event is obtained, tracking contents of the obtained memo event and comparing the tracked contents of the memo event with the pre-stored contact information. Another possible implementation for detecting whether the memo event contains contact information may comprise, after obtaining a memo event, obtaining the content of the memo event by traversing, and comparing the traversed contents of the memo event with the pre-stored contact information. Other implementations are also possible.

Further, when it is detected that the memo event contains contact information, in order to facilitate in displaying the memo events associated with the contact information when the contact information is displayed later, the memo event may be bound to the contact information to form a binding relationship between the memo event and the contact information. There may be a plurality of implementations for binding the memo event to the contact information. For example, a possible implementation for binding the memo event to the contact information may comprise: popping up an option for binding to the contact information when it is detected that the memo event contains contact information, and detecting the operation of selecting the option. Of course, the binding of a memo event to contact information can be implemented in other ways. The present disclosure poses no particular limitation in this regard.

Preferably, after the binding relationship between the memo event and the contact information is formed, the binding relationship may be stored, such that memo events corresponding to the N contact information of the M contact information involved in the communication event being handled can be retrieved directly from the stored binding relationship later. There may be a plurality of implementations for storing the binding relationship. In a particular implementation, a mapping between the memo event and the contact information can be formed, and the mapping may be stored directly. For example, the binding relationship can be stored as shown in table 1, but not limited thereto.

TABLE 1

| Memo events | Contact information |
|---|---|
| to have a dinner with A on March 5 | A 138****** |
| to ask B to return a book | B 150****** |

Preferably, due to the obtained memo event is typically an event to be handled within a certain time period, the user often sets a reminder time for the memo event when the memo event is recorded, so as to ensure that the user is reminded to timely handle this memo event when the reminder time is reached. In such a case, if the current time has overrun the reminder time for the memo event set by the user, there is no need to remind the user of the memo event again. Thus, after the memo event is acquired, the reminder time set for the memo event may also be acquired. After the binding relationship between the memo event and the contact information is formed, whether the current time has overrun the reminder time set for the memo event may be detected, and if the current time has overrun the reminder time set for the memo event, the contact information bound to the memo event may be automatically unbound. After the contact information bound to the memo event has been unbound, the memo events corresponding to the contact information will no longer be displayed when the contact information is displayed.

The preset disclosure poses no specific limitation on the implementation for acquiring the reminder time set for the memo event. The detecting of whether the current time has overrun the reminder time set for the memo event can be implemented by comparing the current time with the reminder time set for the memo event. But the present disclosure is not limited in this regard.

It should be noted that the step 201 is an optional step, and is not required to be executed every time the method of displaying memo events is performed. It is only required to ensure that a memo event is bound to the contact information associated with the memo event before the method of displaying memo events according to the embodiment of the present disclosure is performed.

202: acquiring M contact information involved in a communication event being handled, where M≧1.

The communication event being handled may have a number of types. For example, the communication event can be a phone call, an SMS message, an email, a call record, or the like. The present disclosure poses no particular limitation on implementation for acquiring M contact information involved in a communication event being handled.

For example, in a case where the type of the communication event being handled is to make a phone call and the user currently intends to make a call to some contact in the pre-stored contacts. At this time, the communication event being handled is the user's operation of making a call. When the call is made, the user needs to find the contact information of the contact from a contact list or call records, and therefore the user needs to launch the contact list or the call records. After the user launches the contact list or the call records, the user can acquire the contact information of all the contacts contained in the contact list or the call records. At this time, the M contact information involved in the communication event being handled are the contact information of all the contacts contained in the contact list or the call records. For another example, in a case where the type of the communication event being handled is to send an email, the communication event being handled is the user's operation of sending an email. When the email is sent, the user needs to select one or more recipients from a stored list of recipients. At this time, the M contact information involved in the communication event being handled are the recipient information of all the recipients contained in a mail list.

The present disclosure poses no particular limitation on the specific value of M. Because the number of the contacts involved in the communication event being handled is usually greater than or equal to one, M≧1.

203: determining N contact information from the M contact information, the N contact information being bound to corresponding memo events, respectively.

Because the obtained memo event may be related to part of contacts in the M contact information only, or may be related to all of contacts in the M contact information, it is required to determine N contact information, to which the memo event(s) is bound, from the M contact information. The present disclosure poses no particular limitation on the implementation for determining the N contact information from the M contact information. The specific value of N can be determined in conjunction with the number of the contacts in the M contact information that have been bound to the memo events. In particular, if the number of the contacts in the M contact information that have been bound to memo events is one, then the value of N is one. If the number of the contacts in the M contact information that have been bound to memo events is multiple, then the value of N is great than one but less than M. If all the contacts in the M contact information have been bound to memo events, then the value of N is equal to M.

204: displaying corresponding memo events bound, respectively, to the N contact information when the N contact information are displayed.

Typically, contact information involved in a communication event being handled is displayed during the handling of the communication event. Thus, in order to show memo events in time, corresponding memo events bound, respectively, to the N contact information may be displayed when the N contact information are displayed. Therefore, corresponding memo events bound, respectively, to the N contact information can be displayed timely, so as to improve the efficiency for reminding a user to handle memo events.

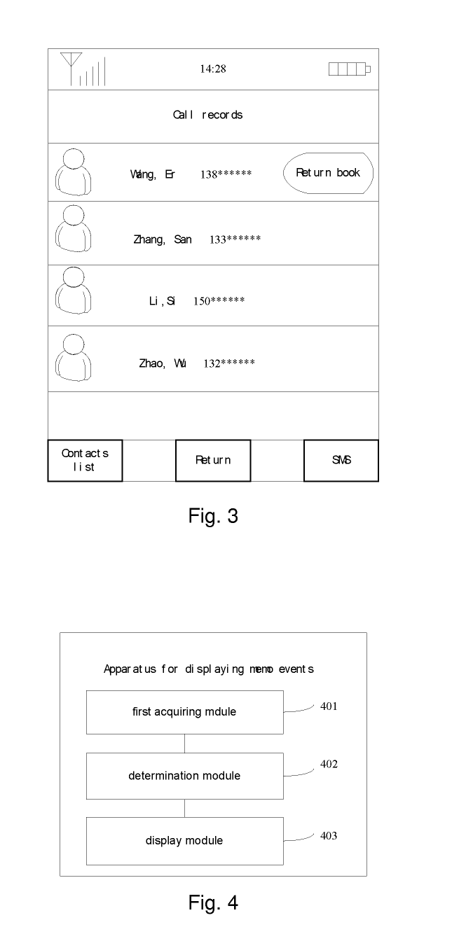

There may be a plurality of implementations for displaying corresponding memo events bound, respectively, to the N contact information when the N contact information are displayed. FIG. 3 is a schematic diagram showing a terminal interface for displaying memo events. In a specific implementation, the displaying of corresponding memo events bound, respectively, to the N contact information may comprise, but not limited to, popping up a floating window for displaying corresponding memo events bound, respectively, to the N contact information.

Further, the number of N contact information, to which the memo events are bound, in the M contact information involved in communication events being handled may be multiple, and the number of the memo events bound to certain contact information of the N contact information may also be multiple. In such a case, after the M contact information involved in communication events being handled are acquired, not only the M contact information but also the memo events bound to the N contact information of the M contact information should be displayed in the display interface. At this time, there may be a mess in the display interface. In order to avoid such a situation, a display rule can be set in advance for displaying corresponding memo events bound, respectively, to the N contact information. In the implementation of displaying corresponding memo events bound, respectively, to the N contact information when the N contact information are displayed, the corresponding memo events bound, respectively, to the N contact information that meet the preset display rule can be displayed when the N contact information are displayed, and the memo events bound, respectively, to the N contact information that do not meet the preset display rule cannot be displayed when the N contact information are displayed.

Thus, before the step of displaying corresponding memo events bound, respectively, to the N contact information when the N contact information are displayed, the method of the present embodiment may further comprise steps of determining whether corresponding memo events bound, respectively, to the N contact information meet the preset display rule; and if the corresponding memo events bound, respectively, to the N contact information meet the preset display rule, the corresponding memo events bound, respectively, to the N contact information are displayed when the N contact information are displayed, and if the corresponding memo events bound, respectively, to the N contact information do not meet the preset display rule, the corresponding memo events bound, respectively, to the N contact information are not displayed when the N contact information are displayed.

The preset display rule can have various contents. The present disclosure poses no particular limitation in this regard. For example, the preset display rule may include, but not limited to, that the time interval between the time for handling the memo event and the current time is within a preset time range. In particular, for each memo event, there is typically a corresponding time for handling the memo event. Thus, an implementation for displaying corresponding memo events bound, respectively, to the N contact information may comprise: determining whether the time interval between the time for handling the memo event and the current time is within a preset time range; and if the time interval between the time for handling the memo event and the current time is within the preset time range, displaying the memo event; otherwise, avoiding displaying the memo event. The present disclosure poses no particular limitation on the length of the preset time range.

In order to facilitate explanation of the process mentioned above, the following are described with reference to a specific example. For example, a memo event bound to some contact information of the N contact information is “October 26, Wang Er's birthday”, and the current time is May 9. That is to say, the time for handling the memo event is October 26, and the current time is May 9. Because the time interval between the two times is relatively long, a reminder for the memo event is not needed. If, from the beginning of May 9, the M contact information involved in the communication event being handled every time contains the contact information for Wang Er, then, whenever a communication event is handled, this memo event will be displayed while the contact information for Wang Er is displayed. As such, it does not achieve the function of reminding the user of handling the memo event, but bring bad user experience in operations. To avoid such a situation, the preset time range can be set to be a week, in order to ensure that the reminder will be started just one week before the time for handling the memo event. Thus, the displaying of the memo event when the N contact information are displayed will be started one week before the time for handling the memo event, and the memo event will not be displayed at any other time than this week when the N contact information are displayed.

As stated above, the above example is illustrated with reference to an example where the preset display rule is that the time interval between the time for handling the memo event and the current time is within a preset time range. Of course, the preset display rule may be another rule. The present disclosure poses no particular limitation in this regard.

Preferably, a same user may operate a plurality of terminals simultaneously, and terminals operated by the user at different times may be different. In order to timely display memo events (i.e. whatever terminal the user currently operates, the user can view the displayed memo event), the plurality of terminals operated by the same user can be bound together. For illustration, in an embodiment of the disclosure, the terminal currently operated by the user can be referred as “the current terminal”, the terminal which is bound to the current terminal can be referred as “the bound terminal”. When a binding relationship between the memo event and the contact information is formed on one current terminal of the plurality of terminals operated by the user, the binding relationship can be synchronized to at least one bound terminal that has been bound. After the binding relationship synchronized is received from the current terminal, the at least one bound terminal may detect in real time whether communications with the N contacts corresponding to the contact information in the binding relationship are being performed. If the bound terminal detects that the communications with the N contacts corresponding to the contact information in the binding relationship are being performed, the bound terminal displays memo events corresponding to the N contact information.

The present disclosure poses no particular limitation on implementations of binding a plurality of terminals, and also poses no particular limitation on implementations of synchronizing the binding relationship to at least one bound terminal by the current terminal. In particular, the synchronizing of the binding relationship to at least one bound terminal by the current terminal may include, but not limited to, synchronizing the binding relationship to at least one bound terminal by exchanging information during an interactive process.

It should be noted that the preferable embodiment relates to an embodiment where memo events corresponding to the N contact information involved in the communication event being handled are displayed on a plurality of terminals when are the plurality of terminals interact with each other by P2P (Peer-to-Peer). For an implementation where memo events corresponding to the N contact information involved in the communication event being handled are displayed on a plurality of terminals when the plurality of terminals interact with each other via a server, please refer to the following preferred embodiment.

Preferably, when a plurality of terminals perform interactions via a server to display on the plurality of terminals memo events corresponding to the N contact information involved in the communication event being handled, the current terminal may submit the binding relationship between the memo event and the contact information to the server after the binding relationship has been formed. In such a case, when a communication event is handled, at least one bound terminal may first retrieve the binding relationship from the server, and determine whether the contact information involved in the communication event being handled exists in the binding relationship, and display memo events corresponding to the N contact information when displayed if it is determined that the M contact information involved in the communication event being handled exists in the binding relationship.

The at least one bound terminal may retrieve the binding relationship from the server in various possible ways. For example, the at least one bound terminal may send to the server a request for acquiring the binding relationship. The server may return the binding relationship to the requesting bound terminal after the bound terminal is verified to be valid, and so on. The at least one bound terminal may determine whether the contact information involved in the communication event being handled exists in the binding relationship in the following way: comparing, by the terminal, the contact information involved in the communication event being handled and the contact information in the binding relationship one by one; and determining whether the contact information involved in the communication event being handled exists in the binding relationship based on the compare result.

By means of determining N contact information of M contact information involved in a communication event being handled, and displaying corresponding memo events bound, respectively, to the N contact information when the N contact information are displayed, the embodiment of the present application can ensure timely displaying of memo events associated with contact information involved in the communication event being handled if it exists, so as to improve efficiency for reminding a user to handle memo events. In addition, because the need for the user to manually trigger displaying memo events is avoided, the embodiment can avoid a situation where a user forgets checking memo events, and can obtain relatively high success rate of reminding a user to handle memo events.

### The Third Embodiment

An embodiment of the present disclosure provides an apparatus for displaying memo events. The apparatus is configured to perform the methods for displaying memo events according to the first and second embodiment described above. Referring to FIG. 4, the apparatus comprises: a first acquiring module 401 configured for acquiring M contact information involved in a communication event being handled, where M≧1; a determination module 402 configured for determining N contact information from the M contact information, the N contact information being bound to corresponding memo events, respectively; and a display module 403 configured for displaying corresponding memo events bound, respectively, to the N contact information, when the N contact information are displayed.

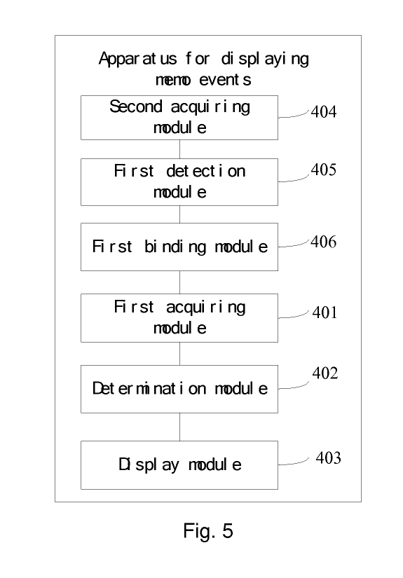

Preferably, referring to FIG. 5, the apparatus further comprises: a second acquiring module 404 configured for acquiring a memo event; a first detection module 405 configured for detecting whether the memo event contains contact information; a first binding module 406 configured for, if the memo event contains contact information, binding the memo event to the contact information to form a binding relationship between the memo event and the contact information.

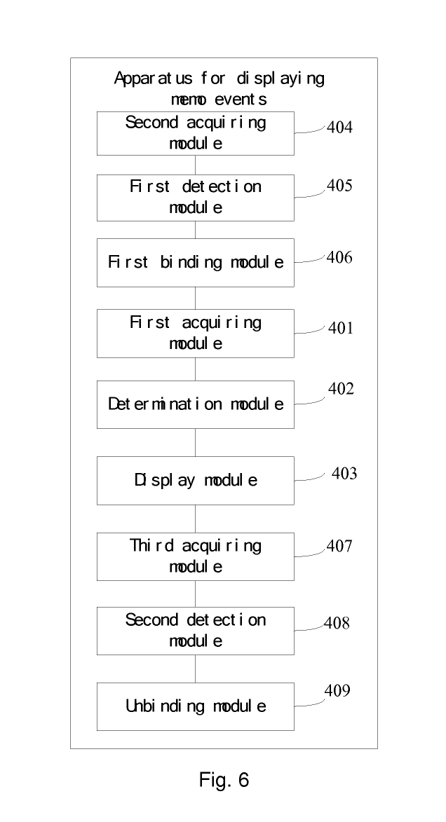

Preferably, referring to FIG. 6, the apparatus further comprises: a third acquiring module 407 configured for acquiring reminder time set for the memo event; a second detection module 408 configured for detecting whether the current time has overrun the reminder time set for the memo event; and an unbinding module 409 configured for, if the current time has overrun the reminder time set for the memo event, automatically unbinding the binding relationship between the memo event and the contact information.

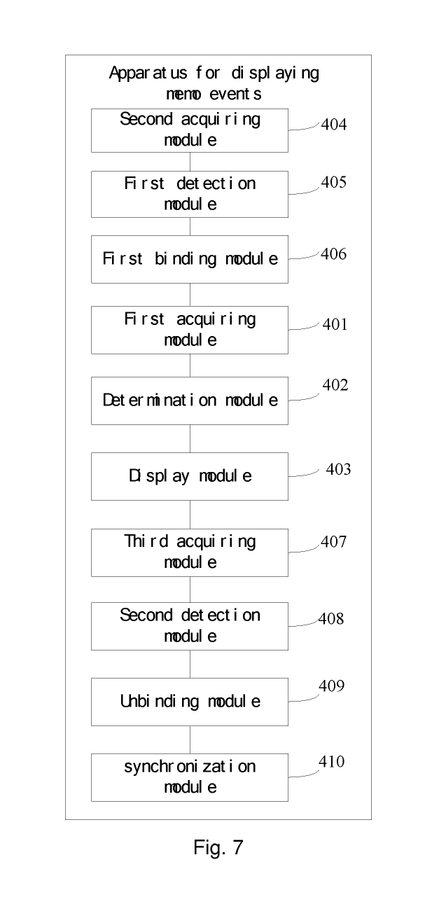

Preferably, referring to FIG. 7, the apparatus further comprises: a synchronization module 410 configured for synchronizing the binding relationship to at least one bound terminal, such that the at least one bound terminal detects in real time whether a communication with a contact corresponding to the contact information in the binding relationship is being performed, and if the bound terminal detects that the communication with the contact corresponding to the contact information in the binding relationship is being performed, the bound terminal displays memo events corresponding to the contact information.

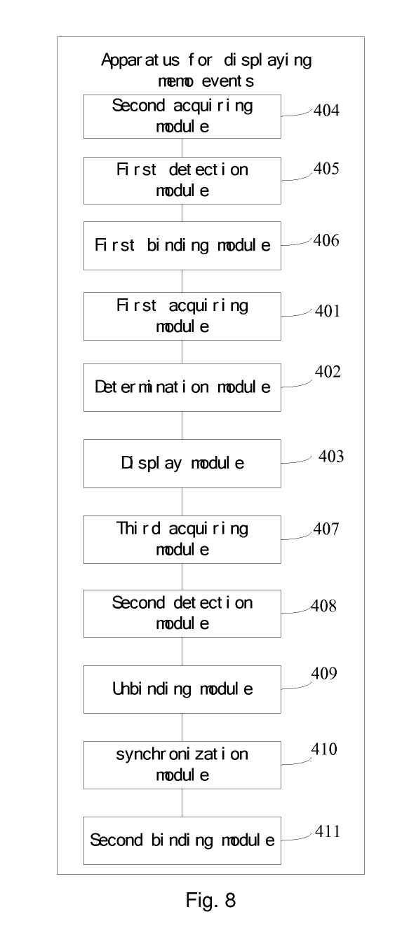

Preferably, referring to FIG. 8, the apparatus further comprises: a second binding module 411 configured for binding to the at least one bound terminal.

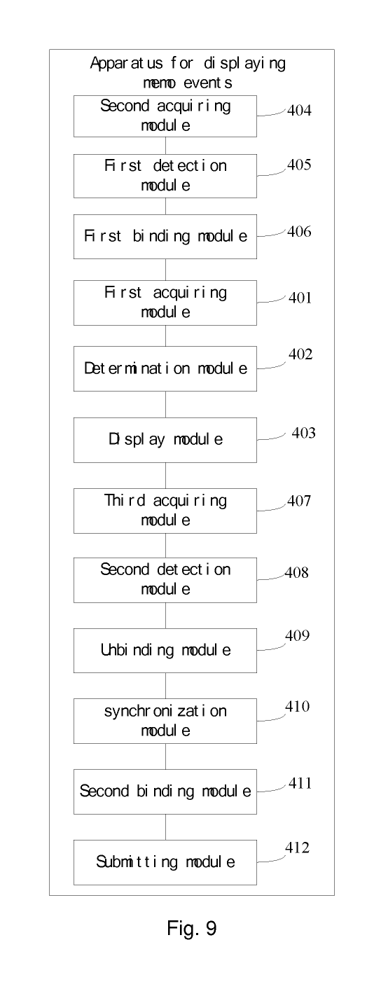

Preferably, referring to FIG. 9, the apparatus further comprises: a submitting module 412 configured for submitting the binding relationship to a server, such that the at least one bound terminal, when a communication event is handled, retrieves the binding relationship from the server, and determines whether the contact information involved in the communication event being handled exists in the binding relationship, and displays memo events corresponding to the contact information when the contact information is displayed if it is determined that the contact information involved in the communication event being handled exists in the binding relationship.

By means of determining N contact information of M contact information involved in a communication event being handled, and displaying corresponding memo events bound, respectively, to the N contact information when the N contact information are displayed, the embodiments can ensure timely displaying of memo events associated with contact information involved in the communication event being handled if it exists, so as to improve efficiency for reminding a user to handle memo events. In addition, because the need for the user to manually trigger the displaying of memo events is avoided, the embodiments can avoid a situation where a user forgets checking memo events, and the success rate of reminding a user to handle memo events is high.

It should be noted that though the apparatus for displaying memo events according to the present embodiments is illustrated with the respective function means mentioned above, it can comprise other function means implementing similar functionalities as required in practice. That is, the internal structure of the apparatus can be divided differently, in order to complete part or all of its functionalities described above. In addition, the apparatus for displaying memo events according to the above embodiments and the method embodiments for displaying memo events according belong to a same inventive idea. The detailed implementation of the apparatus can be understand with reference to the description of the method embodiments and thus is omitted.

The technical solutions provided by embodiments according to the present disclosure provide several advantages:

By means of acquiring N contact information of M contact information involved in a communication event being handled, and displaying respective corresponding memo events bound to the N contact information, respectively, when the N contact information are displayed, it is ensured that the memo events associated with the contact information involved in the communication event being handled may be displayed if there is any communication event being handled. In this way, the efficiency for reminding a user to handle memo events may be improved. In addition, because the need for the user to manually trigger the displaying of the memo events is avoided, the embodiments can avoid the situation where a user forgets checking memo events, and therefore the success rate of reminding a user to handle a memo event is high.

The numbering of the embodiments of the present application is just for the purpose of illustration, and is not intended for performance ranking of the embodiments.

Those skilled in the art should appreciate that parts or all of the embodiments mentioned above can be implemented in pure hardware, or can be implemented in related hardware under instructions of programs. The program may be stored on a computer readable medium. The storage medium may include ROM, magnetic disk storage, optical disk storage, and the like.

The above only describes preferred embodiments of the disclosure, and is not intended to limit the present disclosure. Any changes, equivalent replacements, improvements made within the spirit and principle of the present disclosure shall be embraced by the scope of the present disclosure.

What is claimed is:

1. A method for displaying memo events, the method comprising:
acquiring M contact information involved in a communication event being handled, where M≧1;
determining N contact information from the M contact information, the N contact information being bound to corresponding memo events, respectively; and
displaying the corresponding memo events bound, respectively, to the N contact information when the N contact information are displayed.

2. The method according to claim 1, further comprising:
acquiring a memo event, and detecting whether the memo event contains contact information;
binding the memo event to the contact information to form a binding relationship between the memo event and the contact information if the memo event contains the contact information.

3. The method according to claim 2, wherein after the acquiring of the memo event, the method further comprises:
acquiring reminder time set for the memo event.

4. The method according to claim 3, wherein after the binding of the memo event to the contact information, the method further comprises:
detecting whether the current time has overrun the reminder time set for the memo event; and
automatically unbinding the binding relationship between the memo event and the contact information if the current time has overrun the reminder time set for the memo event.

5. The method according to claim 2, wherein after the binding of the memo event to the contact information, the method further comprises:
synchronizing the binding relationship to at least one bound terminal, such that
the at least one bound terminal detects in real time whether a communication with the contact corresponding to the contact information in the binding relationship is being performed, and the bound terminal displays the memo events corresponding to the contact information if the bound terminal detects that the communication with the contact corresponding to the contact information in the binding relationship is being performed.

6. The method according to claim 5, wherein before the synchronizing of the binding relationship to the at least one bound terminal, the method further comprises:
binding to the at least one bound terminal.

7. The method according to claim 6, wherein after the binding of the memo event to the contact information, the method further comprises:
submitting the binding relationship to a server, such that
the at least one bound terminal, when a communication event is handled, retrieves the binding relationship from the server, and determines whether the contact information involved in the communication event being handled exists in the binding relationship, and displays memo events corresponding to the contact information when the contact information is displayed if it is determined that the contact information involved in the communication event being handled exists in the binding relationship.

8. An apparatus for displaying memo events, the apparatus comprising:
a first acquiring module configured for acquiring M contact information involved in a communication event being handled, where M≧1;
a determination module configured for determining N contact information from the M contact information, the N contact information being bound to corresponding memo events, respectively; and
a display module configured for displaying corresponding memo events bound, respectively, to the N contact information when the N contact information are displayed.

9. The apparatus according to claim 8, further comprising:
a second acquiring module configured for acquiring a memo event;
a first detection module configured for detecting whether the memo event contains contact information; and
a first binding module configured for binding the memo event to the contact information to form a binding relationship between the memo event and the contact information if the memo event contains the contact information.

10. The apparatus according to claim 9, further comprising:
a third acquiring module configured for acquiring reminder time set for the memo event.

11. The apparatus according to claim 10, further comprising:
a second detection module configured for detecting whether the current time has overrun the reminder time set for the memo event; and
an unbinding module configured for automatically unbinding the binding relationship between the memo event and the contact information if the current time has overrun the reminder time set for the memo event.

12. The apparatus according to claim 9, further comprising:
a synchronization module configured for synchronizing the binding relationship to at least one bound terminal, such that
the at least one bound terminal detects in real time whether a communication with the contact corresponding to the contact information in the binding relationship is being performed, and the bound terminal displays the memo events corresponding to the contact information if the bound terminal detects that the communication with the contact corresponding to the contact information in the binding relationship is being performed.

13. The apparatus according to claim 12, further comprising:
a second binding module configured for binding to the at least one bound terminal.

14. The apparatus according to claim 13, further comprising:
a submitting module configured for submitting the binding relationship to a server, such that
the at least one bound terminal, when a communication event is handled, retrieves the binding relationship from the server, and determines whether the contact information involved in the communication event being handled exists in the binding relationship, and displays the memo events corresponding to the contact information when the contact information is displayed if it is determined that the contact information involved in the communication event being handled exists in the binding relationship.
